(19) United States
(12) Patent Application Publication
(10) Pub. No.: US 2024/0120508 A1
(43) Pub. Date: Apr. 11, 2024

(54) SOLID OXIDE FUEL CELLS, SYSTEMS INCLUDING SUCH SOLID OXIDE FUEL CELLS, AND RELATED METHODS OF MAKING

(71) Applicant: Baker Hughes Oilfield Operations LLC, Houston, TX (US)

(72) Inventors: Navin Sakthivel, Spring, TX (US); Wei Chen, Sugar Land, TX (US)

(21) Appl. No.: 17/938,528

(22) Filed: Oct. 6, 2022

(51) Int. Cl. H01M 8/0217; B33Y 80/00; H01M 4/86; H01M 4/90; H01M 8/1253; H01M 8/2425

(52) U.S. Cl. CPC H01M 8/0219; B33Y 80/00; H01M 4/8663; H01M 4/905; H01M 8/1253; H01M 8/2425; H01M 2008/1293

(57) ABSTRACT

A solid oxide fuel cell includes an anode, a cathode, an electrolyte including zirconia between the anode and the cathode, and at least one current collector on a surface of the anode opposite the electrolyte and/or a surface of the cathode opposite the electrolyte. The at least one current collector may include a material of Mₙ₊₁AXₙ composition, wherein M is an early transition metal, A is a Group IIIA element or a Group IVA element, X is carbon (C) or nitrogen (N), and n is an integer from 1 to 3. Related methods and systems are also disclosed.

### TECHNICAL FIELD

This disclosure relates generally to solid oxide fuel cells (SOFCs) and related systems and methods. More specifically, disclosed embodiments relate to zirconia-based SOFCs including current collectors, and to related methods of forming zirconia-based SOFCs and zirconia-based SOFC systems.

### BACKGROUND

Conventional solid oxide fuel cells may include an electrolyte, a cathode, and an anode. A current collector may be used at each electrode (e.g., the cathode and the anode) to extract power from the solid oxide fuel cell. The current collector may be configured to provide a fuel to the anode and an oxidant to the cathode. The electrolyte may conduct negative ions from the cathode to the anode, and the fuel may undergo electrochemical oxidation and generate an electric current. The electric current may then be conducted through the current collectors. Conventional current collectors may be formed of an electrically conductive metal material, such as, for example, a ferritic steel material or a chromium alloy.

In a zirconia-based solid oxide fuel cell, zirconia may be included in each of the components (e.g., the electrolyte, the cathode, and the anode) of the solid oxide fuel cell. However, the conventional metal materials used for current collectors typically have a coefficient of thermal expansion (CTE) at conventional operating temperatures (e.g., between about 700° C. to about 1000° C.) at least substantially greater than a CTE of zirconia at conventional operating temperatures. During operation of a zirconia-based solid oxide fuel cell with conventional current collectors at the conventional operating temperatures, the solid oxide fuel cells may exhibit delamination, debonding, and impaired performance due to the substantial difference in the CTEs of the current collectors and the zirconia-based components of the solid oxide fuel cell.

### BRIEF SUMMARY

Some embodiments of the present disclosure include a solid oxide fuel cell. The solid oxide fuel cell may include an anode, a cathode, an electrolyte including zirconia between the anode and the cathode, and at least one current collector on a surface of the anode opposite the electrolyte and/or a surface of the cathode opposite the electrolyte. The at least one current collector may include a material of Mₙ₊₁AXₙ composition, wherein M is an early transition metal, A is a Group IIIA element or a Group IVA element, X is carbon (C) or nitrogen (N), and n is an integer from 1 to 3.

Additional embodiments of the present disclosure include a method of forming a solid oxide fuel cell. The method may include forming at least one current collector including a material of Mₙ₊₁AXₙ composition adjacent to an anode and/or a cathode of a solid oxide fuel cell module, wherein the solid oxide fuel cell module comprises an electrolyte between the anode and the cathode, wherein M is an early transition metal, A is a Group IIIA element or a Group IVA element, X is carbon (C) or nitrogen (N), and n is an integer from 1 to 3.

Some embodiments of the present disclosure include a solid oxide fuel cell system. The solid oxide fuel cell system may include a stack of solid oxide fuel cells. The solid oxide fuel cells may each include an anode, a cathode, and an electrolyte between the anode and the cathode. The solid oxide fuel cell system may further include current collectors individually interposed between the anode of a first solid oxide fuel cell of a pair of adjacent solid oxide fuel cells and the cathode of a second solid oxide fuel cell of the pair of adjacent solid oxide fuel cells, wherein the current collectors comprise a material of Mₙ₊₁AXₙ composition, where M is an early transition metal, A is a Group IIIA element or a Group IVA element, X is carbon (C) or nitrogen (N), and n is an integer from 1 to 3.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is an isometric view of a solid oxide fuel cell, according to embodiments of the disclosure; and

FIG. 2 is an isometric view of a solid oxide fuel cell system, according to embodiments of the disclosure.

### DETAILED DESCRIPTION

The following description provides specific details, such as specific shapes, specific sizes, specific material compositions, and specific processing conditions, in order to provide a thorough description of embodiments of the present disclosure. However, a person of ordinary skill in the art would understand that the embodiments of the disclosure may be practiced without necessarily employing these specific details. Embodiments of the disclosure may be practiced in conjunction with conventional fabrication techniques employed in the industry. In addition, the description provided below does not form a complete process flow for manufacturing a cutting element or earth-boring tool. Only those process acts and structures necessary to understand the embodiments of the disclosure are described in detail below. Additional acts to form a complete cutting element or a complete earth-boring tool from the structures described herein may be performed by conventional fabrication processes.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “comprising,” “including,” “containing,” “characterized by,” and grammatical equivalents thereof are inclusive or open-ended terms that do not exclude additional, un-recited elements or method steps, but also include the more restrictive terms “consisting of,” “consisting essentially of,” and grammatical equivalents thereof.

As used herein, any relational term, such as “first,” “second,” “front,” “back,” etc., is used for clarity and convenience in understanding the disclosure and accompanying drawings, and does not connote or depend on any specific preference or order, except where the context clearly indicates otherwise.

As used herein, reference to an element as being “on” or “over” another element means and includes the element being directly on top of, adjacent to (e.g., laterally adjacent to, vertically adjacent to), underneath, or in direct contact with the other element. It also includes the element being indirectly on top of, adjacent to (e.g., laterally adjacent to, vertically adjacent to), underneath, or near the other element, with other elements present therebetween. In contrast, when an element is referred to as being “directly on” or “directly adjacent to” another element, no intervening elements are present.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “vertical” and “horizontal” are in reference to a major plane of a structure and are not necessarily defined by Earth's gravitational field. A “horizontal” direction is a direction that is substantially parallel to the major plane of the structure, while a “vertical” or direction is a direction that is substantially perpendicular to the major plane of the structure. The major plane of the structure is defined by a surface of the structure having a relatively large area compared to other surfaces of the structure.

As used herein, the term “early transition metal” means and includes Group III-VII transition metals (e.g., scandium, titanium, vanadium, chromium, manganese, etc.).

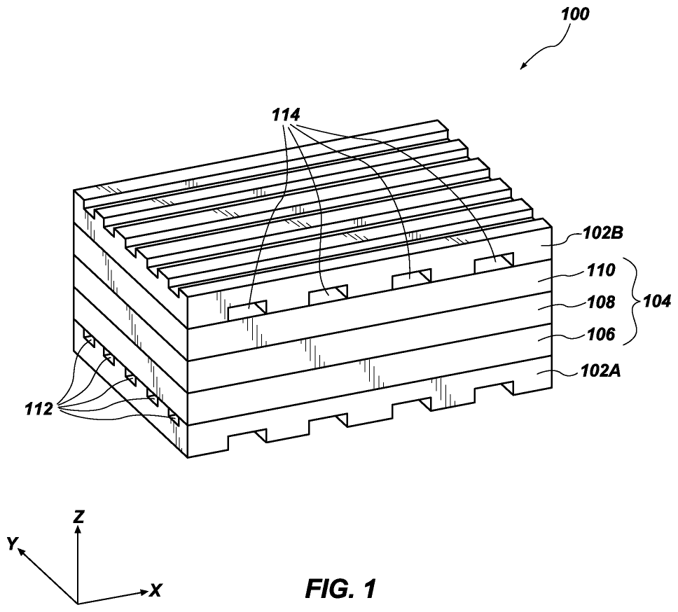

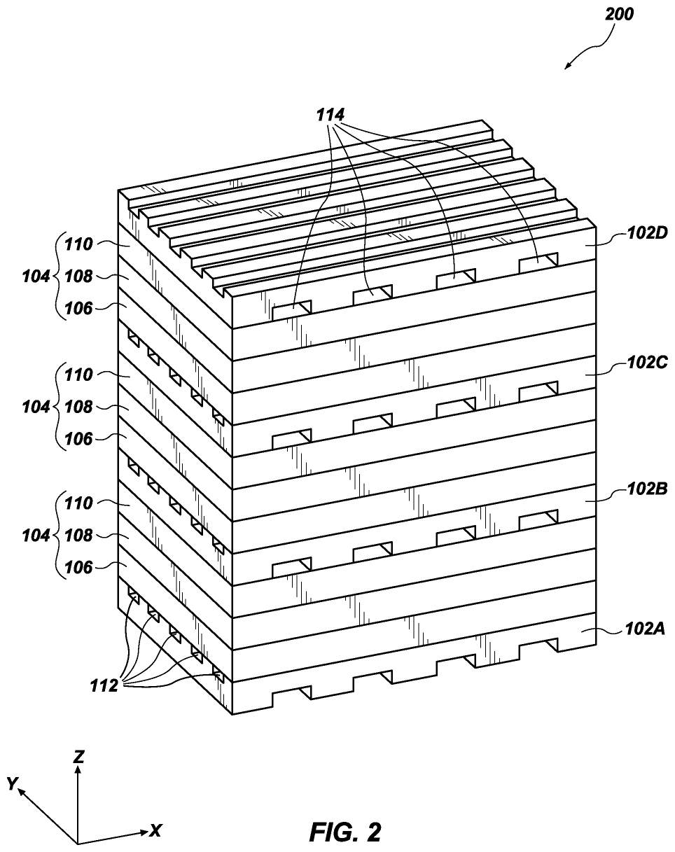

FIG. 1 depicts an isometric view of a solid oxide fuel cell 100, in accordance with embodiments of the disclosure. For convenience in describing FIG. 1, a first direction is defined, shown in FIG. 1, as the X-direction. A second direction, which is transverse (e.g., perpendicular) to the first direction is defined, shown in FIG. 1, as the Y-direction. A third direction, which is transverse (e.g., perpendicular) to the first and second directions is defined, shown in FIG. 1, as the Z-direction. Similar directions are defined, as shown in FIG. 2, as discussed in greater detail below.

As described in further detail below, the solid oxide fuel cell 100 includes a solid oxide fuel cell module 104 disposed between current collectors 102 (e.g., interconnects), including a first current collector 102A and a second current collector 102B. The solid oxide fuel cell 100 is depicted in FIG. 1 as including two current collectors 102. However, the solid oxide fuel cell 100 may include one, or more than two, current collectors 102 in additional embodiments, as described in further detail subsequently herein with reference to FIG. 2. The solid oxide fuel cell module 104 includes an electrolyte 108 disposed between a cathode 106 and an anode 110. The current collectors 102 each include an electrically conductive material of Mₙ₊₁AXₙ composition, where M is an early transition metal, A is a Group IIIA element or a Group IVA element, and X is carbon (C) or nitrogen (N), and n is an integer from 1 to 3. An operating temperature of the solid oxide fuel cell 100 may be within a range of from about 700° C. to about 1000° C. A coefficient of thermal expansion (CTE) of the current collectors 102 at an operating temperature may be within a range of from about 90% to about 110% of a CTE of the electrolyte 108, a CTE of the cathode 106, and/or a CTE of the anode 110 at the same operating temperature. The current collectors 102 having a CTE at an operating temperature within a range of from about 90% to about 110% of a CTE of the electrolyte 108, a CTE of the cathode 106, and/or a CTE of the anode 110 at the same operating temperature may advantageously impede delamination and/or debonding of the current collectors 102 from the solid oxide fuel cell 100, thereby improving performance and reliability of the solid oxide fuel cell 100 at elevated operating temperatures.

The solid oxide fuel cell 100 is depicted in FIG. 1 as being in a stacked configuration including the first current collector 102A, the solid oxide fuel cell module 104 vertically (e.g., in the Z-direction) adjacent to (e.g., over) the first current collector 102A, and the second current collector 102B vertically adjacent to (e.g., over) the solid oxide fuel cell module 104, as shown in FIG. 1. However, the solid oxide fuel cell 100 may exhibit any suitable configuration, such as, for example, a tubular configuration or a complex three dimensional configuration. The first current collector 102A may be adjacent to a surface of the cathode 106 opposite the electrolyte 108. The second current collector 102B may be adjacent to a surface of the anode 110 opposite the electrolyte 108. While the solid oxide fuel cell 100 is depicted in FIG. 1 as including the first current collector 102A and the second current collector 102B, it will be understood by one of ordinary skill in the art that the solid oxide fuel cell 100 may include one or more (e.g., multiple) current collectors 102 adjacent to the cathode 106 and/or the anode 110.

The electrolyte 108 may be disposed between the cathode 106 and the anode 110. In some embodiments, the electrolyte 108 is directly adjacent to (e.g., in direct contact with) the cathode 106 and/or the anode 110. The electrolyte 108 may be at least substantially planar or may exhibit a different geometry (e.g., tubular, non-planar, three dimensional, etc.) according to the configuration of the solid oxide fuel cell 100. The electrolyte 108 may be a solid electrolyte including zirconia. In some embodiments, the electrolyte 108 includes yttria-stabilized zirconia (YSZ) and/or scandia-stabilized zirconia (ScSZ). The electrolyte 108 may have a thickness extending in the Z-direction within a range of from about 5 microns (μm) to about 150 μm, such as, for example, from about 5 μm to about 20 μm, from about 20 μm to about 100 μm, or from about 40 μm to about 60 μm. The electrolyte 108 may have a coefficient of thermal expansion (CTE) at an operating temperature within a range of from about 700° C. to about 1000° C. within a range of from about 10 parts per million (ppm) to about 13 ppm, such as from about 10 ppm to about 11 ppm, from about 10 ppm to about 12 ppm, or from 11 ppm to about 12 ppm. In some embodiments, the electrolyte 108 has a CTE within a range of from about 11 ppm to about 12 ppm at an operating temperature of about 800° C.

The cathode 106 may be disposed between the current collector 102A and the electrolyte 108. In some embodiments, the cathode 106 is directly adjacent to (e.g., in direct contact with) the current collector 102A and/or the electrolyte 108. The cathode 106 may be at least substantially planar or may exhibit a different geometry (e.g., tubular, non-planar, three dimensional, etc.) according to the configuration of the solid oxide fuel cell 100. The cathode 106 may include lanthanium strontium cobalt ferrite (LCSF), lanthanium strontium manganese (LSM), and/or zirconia. In some embodiments, the cathode 106 includes a composite material, the composite material including a lanthanide element (e.g., lanthanum, cerium, gadolinium, etc.) and YSZ, such as, for example, a LSM-YSZ composite and/or a LCSF-YSZ composite. The cathode 106 may have a CTE at an operating temperature within a range of from about 700° C. to about 1000° C. within a range of from about 10 ppm to about 13 ppm, such as from about 10 ppm to about 11 ppm, from about 10 ppm to about 12 ppm, or from 11 ppm to about 12 ppm. In some embodiments, the cathode 106 has a CTE within a range of from about 11 ppm to about 12 ppm at an operating temperature of about 800° C.

The anode 110 may be disposed between the current collector 102B and the electrolyte 108. In some embodiments, the anode 110 is directly adjacent to (e.g., in direct contact with) the current collector 102B and/or the electrolyte 108. The anode 110 may be at least substantially planar or may exhibit a different geometry (e.g., tubular, non-planar, three-dimensional, etc.) according to the configuration of the solid oxide fuel cell 100. The anode 110 may include ceria (e.g., gadolinium doped ceria (GDC), samarium doped ceria (SDC), etc.) and/or zirconia. In some embodiments, the anode 110 includes a cermet material (i.e., a particle matrix composite material comprising a hard ceramic particle phase embedded within a metal matrix phase), such as Ni-YSZ. The anode 110 may have a CTE at an operating temperature within a range of from about 700° C. to about 1000° C. within a range of from about 10 ppm to about 13 ppm, such as from about 10 ppm to about 11 ppm, from about 10 ppm to about 12 ppm, or from 11 ppm to about 12 ppm. In some embodiments, the anode 110 has a CTE within a range of from about 11 ppm to about 12 ppm at an operating temperature of about 800° C.

The first current collector 102A is depicted in FIG. 1 as being adjacent to the cathode 106 of the solid oxide fuel cell module 104. The first current collector 102A and the second current collector 102B may be configured as an interconnect connecting a pair of solid oxide fuel cell modules. In some embodiments, the first current collector 102A is disposed between the cathode 106 of the solid oxide fuel cell module 104 and an anode of an additional solid oxide fuel cell module, thereby connecting a pair of solid oxide fuel cell modules, as described in further detail subsequently herein with reference to FIG. 2. The second current collector 102B is depicted in FIG. 1 as being adjacent to the anode 110 of the solid oxide fuel cell module 104. In some embodiments, the second current collector 102B is disposed between the anode 110 of the solid oxide fuel cell module 104 and a cathode of an additional solid oxide fuel cell module, thereby connecting a pair of solid oxide fuel cell modules, as described in further detail subsequently herein with reference to FIG. 2. The first current collector 102A may be at least substantially similar to the second current collector 102B. In some embodiments, the first current collector 102A is at least substantially identical to the second current collector 102B.

One or more surfaces of each of the current collectors 102 (e.g., the first current collector 102A and the second current collector 102B) may be at least partially non-planar (e.g., convex, concave, ridged, sinusoidal, angled, jagged, V-shaped, U-shaped, irregularly shaped). In some embodiments, one or more surfaces of the current collectors 102 (e.g., the first current collector 102A and the second current collector 102B) adjacent to a cathode (e.g., the cathode 106) and/or an anode (e.g., the anode 110) of a solid oxide fuel cell module (e.g., the solid oxide fuel cell module 104) is/are at least partially non-planar. For example, as depicted in FIG. 1, a major surface of the first current collector 102A adjacent to the cathode 106 and a major surface of the second current collector 102B adjacent to the anode 110 may be at least partially non-planar. In some embodiments, one or more surfaces of the current collectors 102 are at least substantially planar. For example, as depicted in FIG. 1, an exposed surface of the first current collector 102B opposite the cathode 106 and/or an exposed surface of the second current collector 102B opposite the anode 110 may be at least substantially planar. A thickness in the Z-direction of the current collectors 102 may be configured to provide a desired conductivity. For example, a thickness in the Z-direction of the current collectors 102 may be within a range of from about 1 μm to about 1000 μm, such as, for example, from about 50 μm to about 500 μm, from about 100 μm to about 900 μm, from about 300 μm to about 700 μm, or from about 400 μm to about 600 μm.

The major surface of the first current collector 102A adjacent to the cathode 106 may at least partially define channels 112 (e.g., trenches). The channels 112 may extend through the solid oxide fuel cell 100 along an interface region between the cathode 106 and the major surface of the first current collector 102A adjacent to the cathode 106. The channels 112 are depicted in FIG. 1 as exhibiting a rectangular cross-sectional shape. However, the channels 112 may exhibit a different cross-sectional shape, such as, for example, a square shape, a rounded shape, an elliptical shape, a polygonal shape, a U-shape, a V-shape, or an irregular shape. The channels 112 are depicted in FIG. 1 as extending at least substantially horizontally in the X-direction along an at least substantially linear path. However, the channels 112 may extend in any suitable direction (e.g., the Y-direction, diagonally, a combination of directions, etc.) and along any suitable path (e.g., an at least substantially linear path or an at least partially non-linear path). The channels 112 may be configured for delivery of an oxygen source, such as, for example, oxygen gas (O₂) and/or air, therethrough.

The major surface of the second current collector 102B adjacent to the anode 110 may at least partially define channels 114 (e.g., trenches). The channels 114 may extend through the solid oxide fuel cell 100 along an interface region between the anode 110 and the major surface of the second current collector 102B adjacent to the anode 110. The channels 114 are depicted in FIG. 1 as exhibiting a rectangular cross-sectional shape. However, the channels 114 may exhibit a different cross-sectional shape, such as, for example, a square shape, a rounded shape, an elliptical shape, a polygonal shape, a U-shape, a V-shape, or an irregular shape. The channels 114 are depicted in FIG. 1 as extending at least substantially horizontally in the Y-direction along an at least substantially linear path. However, the channels 114 may extend in any suitable direction (e.g., the X-direction, diagonally, a combination of directions, etc.) and along any suitable path (e.g., an at least substantially linear path or an at least partially non-linear path). In some embodiments, the channels 114 are at least substantially perpendicular (e.g., transverse) to the channels 112, as depicted in FIG. 1. The channels 114 may be configured for delivery of a fuel source, such as hydrogen gas (H₂) and/or a hydrocarbon fuel, therethrough.

The first current collector 102A and/or the second current collector 102B include a material of Mₙ₊₁AXₙ composition, where M is an early transition metal, A is a Group IIIA element or a Group IVA element, and X is carbon (C) or nitrogen (N), and n is an integer from 1 to 3. The material of Mₙ₊₁AXₙ composition may be, for example, chromium aluminum carbide (Cr₂AlC), titanium aluminum carbide (Ti₂AlC or Ti₃AlC₂), vanadium aluminum carbide (V₂AlC), zirconium aluminum carbide (Zr₂AlC or Zr₃AlC₂), titanium silicon carbide (Ti₃SiC₂), or combinations thereof. In some embodiments, the first current collector 102A and/or the second current collector 102B include chromium aluminum carbide (Cr₂AlC). A CTE of the first current collector 102A and/or the second current collector 102B at an operating temperature within a range of from about 700° C. to about 1000° C. may be within a range of from about 9 ppm to about 14 ppm, such as, for example, from about 10 ppm to about 11 ppm, from about 10 ppm to about 12 ppm, and from about 11 ppm to about 13 ppm. In some embodiments, a CTE of the first current collector 102A and/or the second current collector 102B at an operating temperature is within a range of from about 90% to about 110% of the CTE of the electrolyte 108, the CTE of the cathode 106, and/or the CTE of the anode 110 at the same operating temperature.

In operation as a solid oxide fuel cell, the oxygen source may be directed through the channels 112 and the fuel source may be directed through the channels 114. The electrolyte 108 may conduct negative oxygen ions from the cathode 106 to the anode 110, and the fuel source may undergo electrochemical oxidation, thereby generating an electric current. The electric current may be conducted through circuits coupled to the cathode 106 and the anode 110. The circuits may be coupled to the cathode 106 and the anode 110 by the current collectors 102.

The solid oxide fuel cell 100 may be operated in reverse as a solid oxide electrolysis cell. In operation as a solid oxide electrolysis cell, a water source (e.g., water vapor) may be directed through the channels 114. An electric current may be directed through the cathode 106 and the anode 110. The water may be reduced to pure hydrogen gas (H₂) and oxygen ions at the interface region between the cathode 106 and the electrolyte 108. The hydrogen gas may diffuse through the cathode 106 and may be collected through the channels 112. The oxygen ions may be oxidized at the interface region between the anode 110 and the electrolyte 108 to form pure oxygen gas (O₂). The pure oxygen gas may be collected through the channels 114.

Since the CTE of the current collectors 102 is within a range of about 10% less than to about 10% greater than the CTE of the electrolyte 106, the CTE of the cathode 106, and/or the CTE of the anode 110, delamination and debonding of the current collectors 102 along the interface regions between the current collectors 102 and the cathode 106 and/or the anode 110 may be reduced or eliminated. Accordingly, the solid oxide fuel cell 100 may exhibit improved performance and reliability at increased operating temperatures (e.g., within a range of from about 700° C. to about 1000° C.).

With continued reference to FIG. 1, a method of forming the solid oxide fuel cell 100, in accordance with embodiments of this disclosure, may include forming the current collectors 102 adjacent to the solid oxide fuel cell module 104. In some embodiments, the method includes forming one or more than two current collectors 102 adjacent to the solid oxide fuel cell module 104. The current collectors 102 may be formed by any suitable formation process, such as, for example, an additive manufacturing process. The additive manufacturing process may include one or more of binder jetting, material jetting (e.g., aerosol jetting, ink jetting, etc.), select laser sintering (SLS), and stereo lithography (SLA). In some embodiments, the current collectors 102 are formed by a binder jetting process and/or a material jetting process.

The cathode 106, the electrolyte 108, and/or the anode 110 of the solid oxide fuel cell modules 104 may be formed by an additive manufacturing process. In some embodiments, the cathode 106, the electrolyte 108, and/or the anode 110 are formed by a binder jetting process and/or a material jetting process. In some embodiments, the current collectors 102, the cathode 106, the electrolyte 108, and/or the anode 110 are separately individually formed by additive manufacturing processes and thereafter assembled to form the solid oxide fuel cell 100. In other embodiments, the current collectors 102, the cathode 106, the electrolyte 108, and/or the anode 110 are formed by sequential additive manufacturing processes, thereby forming the solid oxide fuel cell 100 as a single, continuous structure.

The additive manufacturing process(es) may include selectively bonding precursor particles (e.g., a precursor powder) with a temporary binder (e.g., a selectively cured polymer) to form a green body (e.g., a temporarily bonded structure). The green body may then be subjected to a de-binding process to remove and/or carbonize the temporary binder, thereby forming a white body. The de-binding process may include subjecting the green body to heat and/or a supercritical fluid. A heat source for the de-binding process may include a resistance heat source, a microwave heat source, and/or any suitable heat source configured to control a heating rate and temperature profile. After the de-binding process, an infiltrant may be introduced to the white body. The white body and the infiltrant may be sintered to consolidate the structure and form the current collectors 102, the cathode 106, the electrolyte 108, and/or the anode 110.

When forming the current collectors 102, the precursor particles (e.g., the precursor powder) may include particles of the material of Mₙ₊₁AXₙ composition. In some embodiments, when forming the current collectors 102, the precursor particles include particles of Cr₂AlC. When forming the current collectors 102, the temporary binder may include soluble metal salts, such as, for example, acetates and/or nitrates of chromium and/or aluminum, and/or particles of graphene.

In some embodiments, feedstocks (e.g., the precursor particles, the temporary binder, powder, ink, etc.) of the additive manufacturing process(es) may be configured to provide a desired permeability of the subsequently formed component (e.g., the current collectors 102, the cathode 106, the electrolyte 108, or the anode 110) of the solid oxide fuel cell 100. For example, when forming the cathode 106 and/or the anode 110, the precursor particles may be configured to form capillary channels within the subsequently formed cathode 106 and/or anode 110, in order to enhance adsorption and/or access of fuel and/or oxygen.

By forming the solid oxide fuel cell 100 and components thereof by an additive manufacturing process, the components (e.g., the current collectors 102, the cathode 106, the electrolyte 108, and the anode 110) of the solid oxide fuel cell 100 may be formed to include any desired surface geometry. For example, the components (e.g., the current collectors 102, the cathode 106, the electrolyte 108, and the anode 110) of the solid oxide fuel cell 100 may include any suitable three-dimensional surface geometry, such as, for example a corrugated geometry, an array of hills and valleys, or a topologically optimized geometry configured to maximize contact area for a reaction. Furthermore, the components (e.g., the current collectors 102, the cathode 106, the electrolyte 108, and the anode 110) of the solid oxide fuel cell 100 may be configured to optimize the placement of fuel, air, electrical connectors, cooling mechanisms, etc., according to desired operation parameters of the solid oxide fuel cell 100.

FIG. 2 depicts an isometric of a solid oxide fuel cell system 200, in accordance with embodiments of the disclosure. The solid oxide fuel cell system 200 may operate as a solid oxide fuel cell system or as a solid oxide electrolysis cell system, as previously described in detail with reference to FIG. 1. The solid oxide fuel cell system 200 includes a stack of vertically alternating (e.g., in the Z-direction) solid oxide fuel cell modules 104 and current collectors 102, as previously described in detail with reference to FIG. 1. Each of the solid oxide fuel cell modules 104 includes an electrolyte 106 disposed between a cathode 106 and an anode 110, as previously described in detail with reference to FIG. 1. Each of the solid oxide fuel cell modules 104 is disposed between a pair of current collectors 102, as depicted in FIG. 2.

The solid oxide fuel cell system 200 is depicted in FIG. 2 as including three solid oxide fuel cell modules 104. However, in some embodiments, the solid oxide fuel cell system 200 may include one, two, or more than three solid oxide fuel cell modules 104. The solid oxide fuel cell system 200 is depicted in FIG. 2 as including four current collectors 102 (e.g., a first current collector 102A, a second current collector 102B, a third current collector 102C, and a fourth current collector 102D). However, in some embodiments, the solid oxide fuel cell system 200 may include two, three, or more than four current collectors 102. The solid oxide fuel cell system 200 may include any number of current collectors at least one greater than a number of solid oxide fuel cell modules 104 included in the solid oxide fuel cell system 200. It will be understood by one of ordinary skill in the art that the solid oxide fuel cell system 200 may include any suitable number of solid oxide fuel cell modules 104 and respective current collectors 102.

The current collectors 102 are each disposed adjacent to at least one solid oxide fuel cell module 104. The current collectors 102 may be individually interposed between a pair of adjacent solid oxide fuel cell modules 104. The current collectors 102 may be configured as interconnects connecting the pair of adjacent solid oxide fuel cell modules 104. The current collectors 102 individually interposed between a pair of adjacent solid oxide fuel cell modules 104 may be interposed between a cathode 106 of a first solid oxide fuel cell module 104 of the pair of adjacent solid oxide fuel cell modules 104 and an anode 110 of a second solid oxide fuel cell module of the pair of adjacent solid oxide fuel cell modules 104. As described above with reference to FIG. 1, each of the current collectors 102 may include a material of Mₙ₊₁AXₙ composition, where M is an early transition metal, A is a Group IIIA element or a Group IVA element, and X is carbon (C) or nitrogen (N), and n is an integer from 1 to 3.

Channels 112, as previously described with reference to FIG. 1, may be defined by and extend between a current collector 102 (e.g., any one of the current collectors 102A-C) and a respective adjacent cathode 106. The channels 112 may be configured for delivery of the oxygen source (e.g., oxygen gas (O₂) and/or air) therethrough. Channels 114, as previously described with reference to FIG. 1, may be defined by and extend between a current collector 102 (e.g., any one of the current collectors 102B-D) and a respective adjacent anode 110. The channels 114 may be configured for delivery of the fuel source (e.g., hydrogen gas (H₂) and/or a hydrocarbon fuel) therethrough.

The current collectors 102 may be configured as an interconnect connecting a first solid oxide fuel cell module 104 of an adjacent pair of solid oxide fuel cell modules 104 to a second solid oxide fuel cell module 104 of the adjacent pair of solid oxide fuel cell modules 104. For example, as depicted in FIG. 2, the second current collector 102B and the third current collector 102C are each disposed between a cathode 106 of a first solid oxide fuel cell module 104 of an adjacent pair of solid oxide fuel cell modules 104 and an anode 110 of a second solid oxide fuel cell module 104 of an adjacent pair of solid oxide fuel cell modules 104. When disposed between an adjacent pair of solid oxide fuel cell modules 104, the current collectors 102 may at least partially define both channels 112 and channels 114, as previously described with reference to FIG. 1. For example, as depicted in FIG. 2, the second current collector 102B at least partially defines channels 112 between the second current collector 102B and an adjacent cathode 106 of a solid oxide fuel cell module and at least partially defines channels 114 between the second current collector 102B and an adjacent anode 110 of a solid oxide fuel cell module 104.

Embodiments of the present disclosure further include:

Embodiment 1. A solid oxide fuel cell, comprising: an anode; a cathode; an electrolyte between the anode and the cathode, the electrolyte comprising zirconia; at least one current collector on a surface of the anode opposite the electrolyte and/or a surface of the cathode opposite the electrolyte, wherein the at least one current collector comprises a material of Mₙ₊₁AXₙ composition, wherein M is an early transition metal, A is a Group IIIA element or a Group IVA element, X is carbon (C) or nitrogen (N), and n is an integer from 1 to 3.

Embodiment 2. The solid oxide fuel cell of embodiment 1, wherein a coefficient of thermal expansion of the at least one current collector at an operating temperature is within a range of from about 90% to about 110% of a coefficient of thermal expansion of the electrolyte at the operating temperature.

Embodiment 3. The solid oxide fuel cell of embodiment 1 or embodiment 2, wherein a coefficient of thermal expansion of the at least one current collector is within a range of from about 10 parts per million (ppm) to about 13 ppm at about 800° C.

Embodiment 4. The solid oxide fuel cell of any one of embodiments 1 through 3, wherein the material of Mₙ₊₁AXₙ composition comprises chromium aluminum carbide (Cr₂AlC).

Embodiment 5. The solid oxide fuel cell of any one of embodiments 1 through 4, wherein the electrolyte comprises yttria-stabilized zirconia (YSZ) or scandia-stabilized zirconia (ScSZ).

Embodiment 6. The solid oxide fuel cell of any one of embodiments 1 through 5, wherein the at least one current collector comprises a non-planar surface adjacent to the surface of the anode opposite the electrolyte and/or the surface of the cathode opposite the electrolyte.

Embodiment 7. The solid oxide fuel cell of any one of embodiments 1 through 6, wherein the cathode comprises a composite material, the composite material comprising: a lanthanide element; and yttria-stabilized zirconia (YSZ).

Embodiment 8. The solid oxide fuel cell of any one of embodiments 1 through 7, wherein the anode comprises nickel and yttria-stabilized zirconia (YSZ).

Embodiment 9. A method of forming a solid oxide fuel cell, the method comprising: forming at least one current collector comprising a material of Mₙ₊₁AXₙ composition adjacent to an anode and/or a cathode of a solid oxide fuel cell module, wherein the solid oxide fuel cell module comprises an electrolyte between the anode and the cathode, wherein M is an early transition metal, A is a Group IIIA element or a Group IVA element, X is carbon (C) or nitrogen (N), and n is an integer from 1 to 3.

Embodiment 10. The method of embodiment 9, wherein forming an electrolyte over the anode comprises forming the electrolyte to comprise yttria-stabilized zirconia (YSZ) or scandia-stabilized zirconia (ScSZ).

Embodiment 11. The method of embodiment 9 or embodiment 10, wherein forming at least one current collector comprises forming the at least one current collector to comprise chromium aluminum carbide (Cr₂AlC).

Embodiment 12. The method of any one of embodiments 9 through 11, wherein forming at least one current collector comprises forming a first current collector adjacent to the anode of the solid oxide fuel cell module and forming a second current collector adjacent the cathode of the solid oxide fuel cell module.

Embodiment 13. The method of any one of embodiments 9 through 12, wherein forming at least one current collector comprises forming the at least one current collector by additive manufacturing.

Embodiment 14. The method of any one of embodiments 9 through 13, further comprising forming the anode, the cathode, and the electrolyte of the solid oxide fuel cell by additive manufacturing.

Embodiment 15. The method of any one of embodiments 9 through 14, wherein: forming the at least one current collector by additive manufacturing comprises forming the at least one current collector by binder jetting and/or material jetting; and forming the anode, the cathode, and the electrolyte of the solid oxide fuel cell by additive manufacturing comprises forming the anode, the cathode, and the electrolyte of the solid oxide fuel cell by binder jetting and/or material jetting.

Embodiment 16. A solid oxide fuel cell system, comprising: a stack of solid oxide fuel cells, the solid oxide fuel cells each comprising an anode, a cathode, and an electrolyte between the anode and the cathode; and current collectors individually interposed between the anode of a first solid oxide fuel cell of a pair of adjacent solid oxide fuel cells and the cathode of a second solid oxide fuel cell of the pair of adjacent solid oxide fuel cells, wherein the current collectors comprise a material of Mₙ₊₁AXₙ composition, where M is an early transition metal, A is a Group IIIA element or a Group IVA element, X is carbon (C) or nitrogen (N), and n is an integer from 1 to 3.

Embodiment 17. The solid oxide fuel cell system of embodiment 16, wherein the material of Mₙ₊₁AXₙ composition comprises chromium aluminum carbide (Cr₂AlC).

Embodiment 18. The solid oxide fuel cell system of embodiment 16 or embodiment 17, wherein the electrolyte comprises yttria-stabilized zirconia (YSZ) or scandia-stabilized zirconia (ScSZ).

Embodiment 19. The solid oxide fuel cell system of any one of embodiments 16 through 18, wherein the current collectors comprise at least one non-planar surface adjacent to the anode of the first solid oxide fuel cell and/or adjacent to the cathode of the second solid oxide fuel cell.

Embodiment 20. The solid oxide fuel cell system of any one of embodiments 16 through 19, wherein a coefficient of thermal expansion of the current collectors is within a range of from about 10 ppm to about 13 ppm at about 800° C.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed is:

1. A solid oxide fuel cell, comprising:
an anode;
a cathode;
an electrolyte between the anode and the cathode, the electrolyte comprising zirconia; and
at least one current collector on a surface of the anode opposite the electrolyte and/or a surface of the cathode opposite the electrolyte,
wherein the at least one current collector comprises a material of Mₙ₊₁AXₙ composition, wherein M is an early transition metal, A is a Group IIIA element or a Group IVA element, X is carbon (C) or nitrogen (N), and n is an integer from 1 to 3.

2. The solid oxide fuel cell of claim 1, wherein a coefficient of thermal expansion of the at least one current collector at an operating temperature is within a range of from about 90% to about 110% of a coefficient of thermal expansion of the electrolyte at the operating temperature.

3. The solid oxide fuel cell of claim 1, wherein a coefficient of thermal expansion of the at least one current collector is within a range of from about 10 parts per million (ppm) to about 13 ppm at about 800° C.

4. The solid oxide fuel cell of claim 1, wherein the material of Mₙ₊₁AXₙ composition comprises chromium aluminum carbide (Cr₂AlC).

5. The solid oxide fuel cell of claim 1, wherein the electrolyte comprises yttria-stabilized zirconia (YSZ) or scandia-stabilized zirconia (ScSZ).

6. The solid oxide fuel cell of claim 1, wherein the at least one current collector comprises a non-planar surface adjacent to the surface of the anode opposite the electrolyte and/or the surface of the cathode opposite the electrolyte.

7. The solid oxide fuel cell of claim 1, wherein the cathode comprises a composite material, the composite material comprising:
a lanthanide element; and
yttria-stabilized zirconia (YSZ).

8. The solid oxide fuel cell of claim 1, wherein the anode comprises nickel and yttria-stabilized zirconia (YSZ).

9. A method of forming a solid oxide fuel cell, the method comprising:
forming at least one current collector comprising a material of Mₙ₊₁AXₙ composition adjacent to an anode and/or a cathode of a solid oxide fuel cell module, wherein the solid oxide fuel cell module comprises an electrolyte between the anode and the cathode,
wherein M is an early transition metal, A is a Group IIIA element or a Group IVA element, X is carbon (C) or nitrogen (N), and n is an integer from 1 to 3.

10. The method of claim 9, wherein forming an electrolyte over the anode comprises forming the electrolyte to comprise yttria-stabilized zirconia (YSZ) or scandia-stabilized zirconia (ScSZ).

11. The method of claim 9, wherein forming at least one current collector comprises forming the at least one current collector to comprise chromium aluminum carbide (Cr₂AlC).

12. The method of claim 9, wherein forming at least one current collector comprises forming a first current collector adjacent to the anode of the solid oxide fuel cell module and forming a second current collector adjacent the cathode of the solid oxide fuel cell module.

13. The method of claim 9, wherein forming at least one current collector comprises forming the at least one current collector by additive manufacturing.

14. The method of claim 13, further comprising forming the anode, the cathode, and the electrolyte of the solid oxide fuel cell by additive manufacturing.

15. The method of claim 14, wherein:
forming the at least one current collector by additive manufacturing comprises forming the at least one current collector by binder jetting and/or material jetting; and
forming the anode, the cathode, and the electrolyte of the solid oxide fuel cell by additive manufacturing comprises forming the anode, the cathode, and the electrolyte of the solid oxide fuel cell by binder jetting and/or material jetting.

16. A solid oxide fuel cell system, comprising:
a stack of solid oxide fuel cells, the solid oxide fuel cells each comprising an anode, a cathode, and an electrolyte between the anode and the cathode; and
current collectors individually interposed between the anode of a first solid oxide fuel cell of a pair of adjacent solid oxide fuel cells and the cathode of a second solid oxide fuel cell of the pair of adjacent solid oxide fuel cells,
wherein the current collectors comprise a material of Mₙ₊₁AXₙ composition, where M is an early transition metal, A is a Group IIIA element or a Group IVA element, X is carbon (C) or nitrogen (N), and n is an integer from 1 to 3.

17. The solid oxide fuel cell system of claim 16, wherein the material of Mₙ₊₁AXₙ composition comprises chromium aluminum carbide (Cr₂AlC).

18. The solid oxide fuel cell system of claim 16, wherein the electrolyte comprises yttria-stabilized zirconia (YSZ) or scandia-stabilized zirconia (ScSZ).

19. The solid oxide fuel cell system of claim 16, wherein the current collectors comprise at least one non-planar surface adjacent to the anode of the first solid oxide fuel cell and/or adjacent to the cathode of the second solid oxide fuel cell.

20. The solid oxide fuel cell system of claim 16, wherein a coefficient of thermal expansion of the current collectors is within a range of from about 10 ppm to about 13 ppm at about 800° C.
